(19) United States
(12) Patent Application Publication
(10) Pub. No.: US 2026/0303881 A1
(43) Pub. Date: Oct. 1, 2026

(54) DISTRIBUTED VIDEO QUALITY EVALUATIONS

(71) Applicant: NETFLIX, INC., Los Gatos, CA (US)

(72) Inventors: Weiguo ZHENG, San Jose, CA (US); Tianxiang GAO, Cupertino, CA (US); Michael Aki SCHASSBERGER, San Ramon, CA (US); May-Chen MARTIN-KUO, Los Gatos, CA (US)

(21) Appl. No.: 19/632,090

(22) Filed: Mar. 27, 2026

Related U.S. Application Data
(60) Provisional application No. 63/780,807, filed on Mar. 31, 2025.

(51) Int. Cl. H04N 21/234; H04N 21/4425

(52) U.S. Cl. CPC H04N 21/23418; H04N 21/4425

(57) ABSTRACT

A host device performs distributed video quality evaluation across multiple devices under test (DUTs). Configuration data identifies DUTs, test videos, reference files, frame-capture parameters, and stages of a video-processing pipeline at which frames are to be captured. The host device assigns test cycles to available DUTs, coordinates execution of the test cycles, obtains captured frames generated by the DUTs during playback of the test videos, and analyzes the captured frames relative to the reference files to generate objective video quality metrics. The host device can aggregate metrics across frames, stages, test cycles, and DUTs, and can perform actions based at least on the aggregated metrics, including reporting and comparison of DUT performance. In some embodiments, coordination is performed using status files associated with respective DUTs, which enables automated parallel execution, exception recovery, and deployment across on-premises, network-based, or cloud-based environments.

### CROSS-REFERENCE TO RELATED APPLICATIONS

The present application claims the benefit of U.S. Provisional Application titled, “TECHNIQUES FOR IMPLEMENTING AUTOMATED DEVICE VIDEO QUALITY EVALUATIONS,” filed on Mar. 31, 2025, and having Serial No. 63/780,807. The subject matter of this related application is hereby incorporated herein by reference.

### BACKGROUND

### Field of the Invention

Embodiments of the present disclosure relate generally to computer science, streaming and audio processing technologies and, more specifically, to performing distributed video quality evaluations.

### Description of the Related Art

Video quality evaluation constitutes an important aspect of workflows for various video-processing applications. Such evaluation can include rendering, capturing, and analyzing large numbers of video frames under differing conditions, including different scenes, compression ratios, and compression techniques. In many implementations, useful evaluation further involves comparing outputs generated by multiple devices under test (DUTs), where respective DUTs may render video according to different processing parameters and objective metrics may be applied to corresponding frames generated by the DUTs.

Video quality evaluation is further complicated in systems that incorporate additional video-processing operations, including AI-based operations such as upscaling and super-resolution performed by systems on chip (SOCs) or other processing hardware. In such systems, rendering, frame capture, and analysis may need to occur at multiple stages of a video-processing pipeline, including post-decoding, post-processing, and/or upscaling stages, in order to isolate contributions of individual stages and identify artifacts introduced at particular stages. As a result, video quality evaluation presents technical challenges associated with synchronized control of rendering operations, stage-specific frame capture, transfer of captured data, and coordinated analysis across multiple DUTs.

Conventional approaches to video quality evaluation often rely on manual operator involvement to initiate tests, monitor DUT execution, retrieve output data, and start subsequent tests. Because such approaches depend on operator-driven coordination, the approaches often do not support sustained parallel execution across multiple DUTs or automated transition from one test cycle to a subsequent test cycle. Instead, a given DUT may remain idle while awaiting operator action, or testing may proceed serially on a single DUT. As a result, conventional approaches exhibit technical deficiencies including inefficient utilization of DUT and computing resources, increased latency between testing operations, and limited automated test-execution throughput.

Conventional approaches also frequently lack a centralized orchestration framework for coordinating frame capture, command execution, status monitoring, data collection, file transfer, and analysis across multiple DUTs. As a result, such operations are often implemented in a fragmented or ad hoc manner, with differing procedures applied across devices or across test runs. Such a lack of centralized technical control can reduce repeatability and reproducibility of testing, impair synchronization across DUTs, and increase susceptibility to errors in status monitoring, data handling, file management, and result verification. In addition, inconsistent communication and reporting mechanisms between DUTs and coordinating systems can reduce the reliability of inter-device coordination and diminish the consistency of generated test results.

Conventional approaches further present technical limitations with respect to scalability and adaptability. For example, as the number of DUTs increases, manual and ad hoc coordination mechanisms become progressively more difficult to maintain, thereby limiting the ability of conventional systems to scale. Conventional approaches may also be poorly suited for evaluation at multiple stages of a video-processing pipeline, including post-decoding, post-processing, and upscaling stages, because such approaches do not provide a common framework for coordinated capture and analysis across differing processing points. Additionally, conventional techniques may be difficult to deploy consistently across different computing environments, including on-premises and network-based or cloud-based environments, due to lack of a unified orchestration and communication architecture.

As the foregoing illustrates, what is needed in the art are more effective techniques for performing distributed video quality evaluations.

### SUMMARY OF THE EMBODIMENTS

One embodiment sets forth a method for performing distributed video quality evaluations. According to some embodiments, the method includes the steps of obtaining configuration data associated with a plurality of devices under test (DUTs) and a plurality of test cycles; assigning the plurality of test cycles to available DUTs of the plurality of DUTs; obtaining, from the plurality of DUTs, captured frames generated during execution of the plurality of test cycles; analyzing the captured frames relative to reference data to generate objective video quality metrics; aggregating the objective video quality metrics across at least a subset of the plurality of test cycles to generate aggregated objective video quality metrics; and performing at least one action based at least on the aggregated objective video quality metrics.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques reduce or eliminate manual operator intervention in execution of a testing workflow. For example, the disclosed techniques enable automated execution of multiple tests in parallel across multiple devices under test (DUTs), and further enable sequential execution of successive test cycles without requiring operator interaction between tests or test cycles. As a result, the disclosed techniques reduce idle time between test operations, reduce synchronization delays associated with manual coordination, and reduce operator-induced variability in test execution. In this manner, the disclosed techniques improve utilization of computing and DUT resources and increase automated test-execution throughput relative to conventional techniques.

Another technical advantage of the disclosed techniques relative to the prior art is that the disclosed techniques enable centralized orchestration of test execution, for example through a host machine that coordinates operation of multiple DUTs. Such centralized orchestration enables consistent scheduling, command issuance, data collection, and file handling across DUTs according to a common control scheme. As a result, the disclosed techniques improve repeatability and reproducibility of test execution, enable objective and consistent verification using common evaluation criteria, and reduce errors arising from inconsistent local execution behavior or non-uniform data handling. Further, use of a consistent communication scheme for test progress information, test data, and files between the DUTs and the host machine improves reliability of inter-device coordination and promotes generation of more consistent and technically reliable test results.

Another technical advantage of the disclosed techniques relative to the prior art is that the disclosed techniques are scalable and adaptable across differing test environments and video-processing configurations. For example, the disclosed techniques enable addition, removal, or modification of DUTs participating in a testing workflow without requiring redesign of the overall orchestration framework. The disclosed techniques further support video quality evaluation at multiple stages of a video-processing pipeline, including post-decoding, post-processing, and/or upscaling stages, such that quality analysis can be selectively performed at different processing points within one or more DUTs. This improves flexibility of the testing architecture while preserving a common automated control and data-collection framework.

Yet another technical advantage of the disclosed techniques relative to the prior art is that the disclosed techniques can be deployed in different computing environments, including on-premises architectures and cloud-based environments in which communication with DUTs occurs over a network such as the Internet. Accordingly, the disclosed techniques enable a common orchestration and monitoring framework to be used across distributed computing environments, which improves portability of the testing system and allows technically consistent test control, status monitoring, and result collection across heterogeneous infrastructure.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a network infrastructure used to execute video quality evaluation, according to various embodiments.

FIG. 2 is a more detailed conceptual illustration of the host device of FIG. 1, according to various embodiments.

FIG. 3 is a more detailed conceptual illustration of the DUT of FIG. 1, according to various embodiments.

FIG. 4 illustrates a sequence diagram for a test cycle, including transmitting and testing test videos, capturing frames, and aggregating the captured frames, according to some embodiments.

FIG. 5 illustrates a flow diagram of a method for executing a test cycle and generating objective metrics by the host device, according to various embodiments.

FIG. 6 illustrates a flow diagram of a method for executing a test cycle by DUT 116, according to various embodiments.

FIG. 7 is a more detailed illustration of a computing device that can implement the functionalities of any of the entities illustrated in FIG. 1, according to various embodiments.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

Video quality evaluation is an important but technically complex aspect of video-processing workflows, particularly where large numbers of frames are rendered, captured, and analyzed under different scenes, compression settings, and processing conditions, and where outputs from multiple devices under test are compared using objective metrics. The complexity increases when video-processing pipelines include operations such as AI-based upscaling or super-resolution, given evaluation may need to occur at multiple stages, such as post-decoding, post-processing, and upscaling, to isolate stage-specific effects and artifacts. Conventional approaches rely heavily on manual operator involvement to initiate tests, monitor execution, retrieve data, and advance workflows, which limits parallelism, increases idle time and latency, and reduces overall throughput. Such approaches also tend to lack centralized orchestration for coordinating commands, status monitoring, frame capture, file transfer, and analysis across multiple DUTs, which results in fragmented execution, inconsistent procedures, reduced repeatability, synchronization issues, and greater risk of handling and verification errors. In addition, conventional techniques scale poorly as the number of DUTs grows, are not well adapted to coordinated multi-stage pipeline evaluation, and often cannot be deployed consistently across on-premises, network-based, and cloud-based environments because such techniques lack a unified orchestration and communication architecture.

To address the foregoing considerations, the disclosed techniques involve performing automated video quality evaluations across multiple devices, including devices under test (DUTs). In some embodiments, a host device coordinates execution of test cycles on one or more DUTs, where each test cycle includes providing test videos and corresponding reference files to a DUT, causing the DUT to execute playback of the test videos, capturing frames generated during playback, retrieving the captured frames from the DUT, and analyzing the captured frames relative to the reference files to generate objective video quality metrics. In some embodiments, the objective video quality metrics include video multi-method assessment fusion (VMAF) scores and/or VMAF-no enhancement gain (VMAF-NEG) scores.

In some embodiments, the host device communicates with each DUT using a file-based coordination scheme that includes a host status file and a DUT status file. The DUT status file can indicate a testing state of the DUT, such as IDLE, BUSY, or DONE, and the host status file can indicate a command for the DUT, such as NOP, TESTING, RECEIVING, or SKIPPING. The host device can identify a DUT in the IDLE state, transmit test content for a test cycle to the DUT, and issue the TESTING command. In response, the DUT can update the DUT status file to BUSY, execute playback and frame capture operations, and then update the DUT status file to DONE when captured frames are ready for transfer. After detecting the DONE state, the host device can issue the RECEIVING command, retrieve the captured frames, request deletion of test-cycle files from the DUT, and return the DUT to an IDLE state for a subsequent test cycle.

In some embodiments, the DUT executes playback using one or more video-processing stages of a video pipeline, including decoding, post-processing, upscaling, and/or AI-based super-resolution. Frames can be captured at one or more specified stages of the video pipeline according to configuration data and/or one or more test scripts. The host device can analyze the captured frames relative to corresponding reference files and can aggregate resulting objective metric data across captured frames, stages, test cycles, and DUTs.

In some embodiments, the host device maintains configuration data identifying DUTs, connectivity information for the DUTs, test videos, reference files, frame-capture parameters, and pipeline stages for frame capture. The host device can assign test videos to DUTs based on DUT readiness and can coordinate multiple DUTs concurrently while maintaining separate status files for respective DUTs. In some embodiments, when an expected state transition does not occur, the host device performs exception recovery that includes retry operations and, if appropriate, issuance of a SKIPPING command to terminate a current test cycle and proceed to another test cycle. The disclosed techniques can be implemented in on-premises environments, network-based environments, cloud-based environments, or combinations thereof.

At least one technical advantage of the disclosed techniques relative to the prior art is that the disclosed techniques reduce or eliminate manual operator intervention in execution of a testing workflow. For example, the disclosed techniques enable automated execution of multiple tests in parallel across multiple devices under test (DUTs), and further enable sequential execution of successive test cycles without requiring operator interaction between tests or test cycles. As a result, the disclosed techniques reduce idle time between test operations, reduce synchronization delays associated with manual coordination, and reduce operator-induced variability in test execution. In this manner, the disclosed techniques improve utilization of computing and DUT resources and increase automated test-execution throughput relative to conventional techniques.

Another technical advantage of the disclosed techniques relative to the prior art is that the disclosed techniques enable centralized orchestration of test execution, for example through a host machine that coordinates operation of multiple DUTs. Such centralized orchestration enables consistent scheduling, command issuance, data collection, and file handling across DUTs according to a common control scheme. As a result, the disclosed techniques improve repeatability and reproducibility of test execution, enable objective and consistent verification using common evaluation criteria, and reduce errors arising from inconsistent local execution behavior or non-uniform data handling. Further, use of a consistent communication scheme for test progress information, test data, and files between the DUTs and the host machine improves reliability of inter-device coordination and promotes generation of more consistent and technically reliable test results.

Another technical advantage of the disclosed techniques relative to the prior art is that the disclosed techniques are scalable and adaptable across differing test environments and video-processing configurations. For example, the disclosed techniques enable addition, removal, or modification of DUTs participating in a testing workflow without requiring redesign of the overall orchestration framework. The disclosed techniques further support video quality evaluation at multiple stages of a video-processing pipeline, including post-decoding, post-processing, and/or upscaling stages, such that quality analysis can be selectively performed at different processing points within one or more DUTs. This improves flexibility of the testing architecture while preserving a common automated control and data-collection framework.

Yet another technical advantage of the disclosed techniques relative to the prior art is that the disclosed techniques can be deployed in different computing environments, including on-premises architectures and cloud-based environments in which communication with DUTs occurs over a network such as the Internet. Accordingly, the disclosed techniques enable a common orchestration and monitoring framework to be used across distributed computing environments, which improves portability of the testing system and allows technically consistent test control, status monitoring, and result collection across heterogeneous infrastructure.

These technical advantages represent one or more technological advancements over prior art approaches.

### System Overview

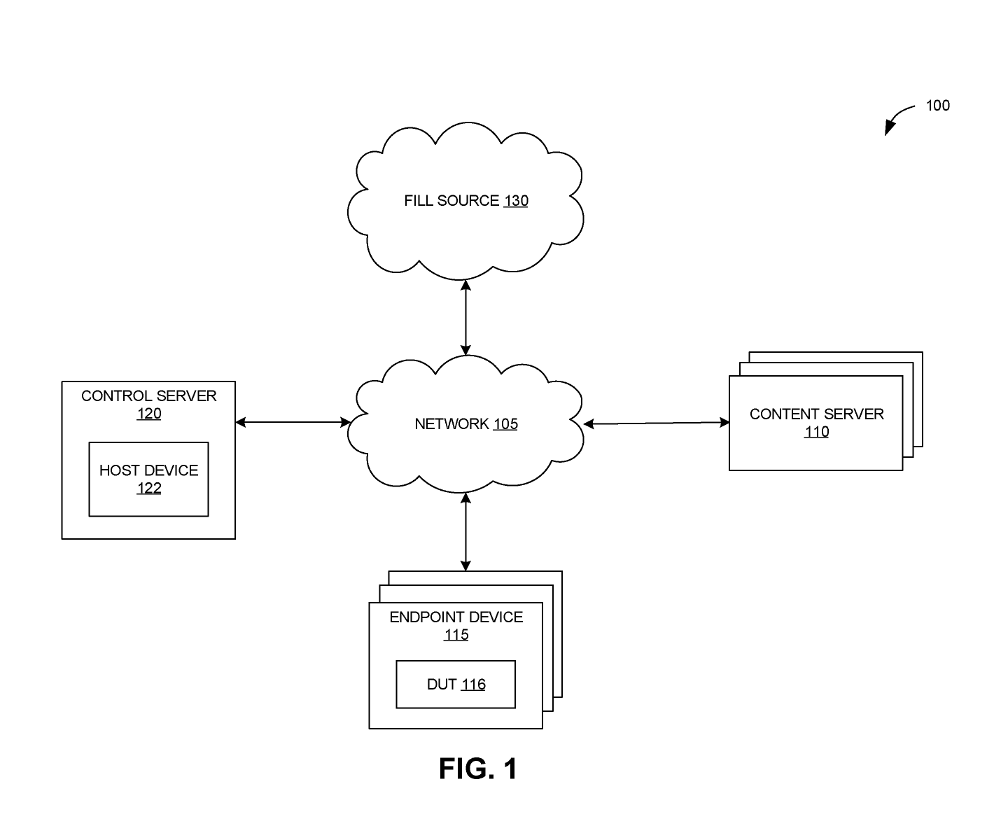

FIG. 1 illustrates a network infrastructure 100 used to execute video quality evaluation, according to various embodiments. As shown, network infrastructure 100 includes content servers 110, control server 120, fill sources 130, and endpoint devices 115, each of which is connected via a communications network 105. Control server 120 includes, without limitation, a host device 122. Endpoint device 115 includes, without limitation, a DUT 116.

Endpoint device 115 communicates with control server 120 to interact with one or more content servers 110 (also referred to as “caches” or “nodes”) within network 105. Endpoint device 115 downloads content such as textual data, graphical data, audio data, video data, and other types of data from content servers 110 via communication with control server 120. In some embodiments, such a communication scheme is configurable. The downloadable content, also referred to herein as a “file,” is then presented to a user of one or more endpoint devices 115. In various embodiments, endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content such as text, images, video, and/or audio content to a user. In some embodiments, content can also be received from control server 120. Control server 120 coordinates and instructs content server 110 to deliver content to endpoint device 115.

Each content server 110 may include a web server, database, and server application (not illustrated in FIG. 1) configured to communicate with control server 120 to determine the location and availability of various files that are tracked and managed by control server 120. Each content server 110 may further communicate with fill sources 130 and one or more other content servers 110 to fill each content server 110 with copies of various files.

In addition, content servers 110 can deliver content to endpoint devices 115. The files may then be distributed from content servers 110 or via a broader content distribution network. In some embodiments, content servers 110 enable users to authenticate (e.g., using a username and password) to access files stored on content servers 110. Although only a single control server 120 is shown in FIG. 1, in various embodiments multiple control servers 120 may be implemented to track and manage files.

In various embodiments, fill source 130 may include an online storage service (e.g., Amazon® Simple Storage Service, Google® Cloud Storage, etc.) in which a catalog of files, including thousands or millions of files, is stored and accessed to fill content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond fill source 130 to the extent desired or necessary.

DUT 116 corresponds to an endpoint device 115 that renders video content such as test videos. DUT 116 is configured to receive a test script independent of execution of a test cycle. DUT 116 then receives the test videos from host device 122, renders the test videos, captures frames from the test videos, and sends back the captured frames to host device 122.

In some embodiments, DUT 116 includes a system-on-chip (SOC) that performs video decoding, upscaling, postprocessing, and/or rendering operations including AI super-resolution (AISR) as stages of a video rendering pipeline. In some embodiments, such stages are executed without an SOC.

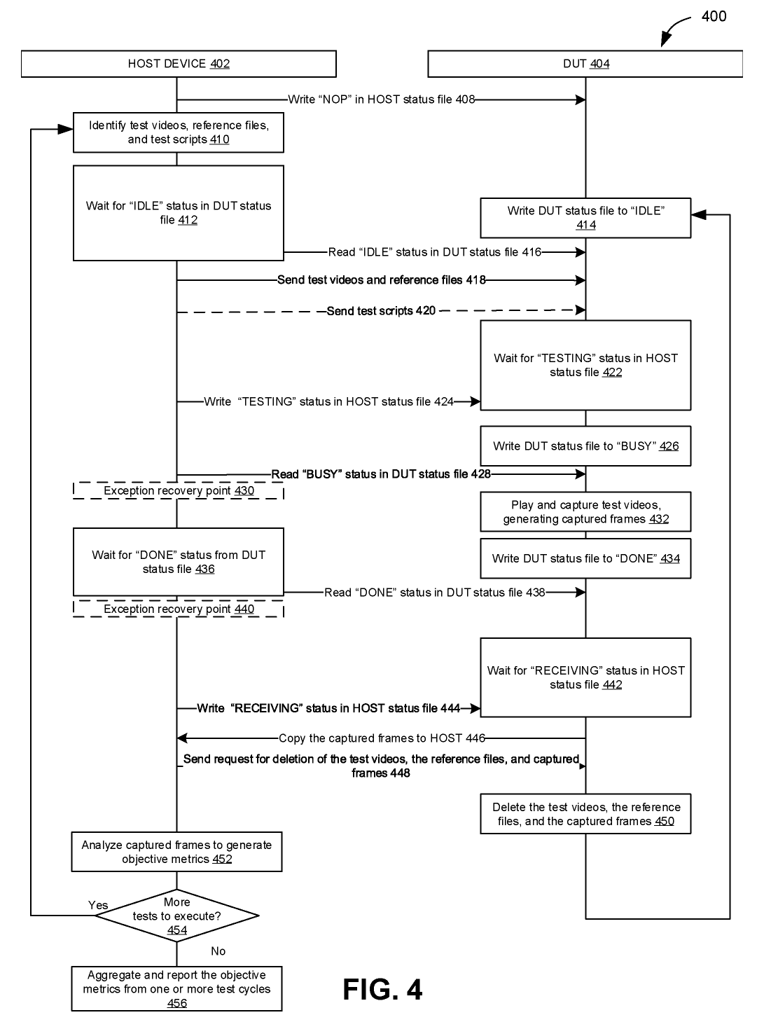

Each DUT 116 maintains a DUT status file indicating various testing states of DUT 116. In some embodiments, the DUT status file includes an IDLE state, a BUSY state, or a DONE state. DUT 116 transitions from the IDLE state to the BUSY state upon receipt of a command from host device 122. While in the BUSY state, DUT 116 renders the test videos and executes stages of the video rendering pipeline, such as decoding, upscaling including AISR, and/or postprocessing. DUT 116 captures frames at predefined intervals and transmits the captured frames to host device 122 for computation of objective metrics. Upon completion of frame capture and transfer of the captured frames, DUT 116 sets the DUT status file to the DONE state. Operation of DUT 116 is described in greater detail in conjunction with FIG. 4.

Notably, video quality evaluation often necessitates comparative tests in which results generated by different devices or hardware implementations are compared. It is desirable to analyze videos generated by different device or hardware implementations in order to evaluate how the hardware implementations affect stages of the video pipeline. In such comparative testing, different test videos are distributed across multiple DUTs 116, or a same test video can be executed on multiple DUTs 116 to compare resulting output. Compared with previous techniques, the disclosed techniques enable video quality evaluation using objective metrics at one or more specified stages of the video pipeline executed by DUT 116, allowing analysis of how different hardware implementations (e.g., different SOC implementations) affect video quality.

Host device 122 communicates with one or more DUTs 116 via network 105. Host device 122 transmits the test script to DUT 116, where the test script includes information from configuration 222 relevant to DUT 116 for execution of the test cycle. Host device 122 then transmits the test videos to DUT 116 based on readiness of DUT 116 and then issues playback commands to DUT 116. Host device 122 then receives the captured frames generated by DUT 116 through network 105. In some embodiments, host device 122 coordinates retrieval of the test videos from content server 110. In some embodiments, host device 122 operates in an environment in which content server 110 and fill source 130 provide the test videos accessible through network 105.

Host device 122 analyzes the captured frames to generate objective metrics. In some implementations, host device 122 invokes a fast forward moving picture experts group (FFMPEG) and/or a video multi-method assessment fusion (VMAF) model to compute VMAF and/or VMAF-No Enhancement Gain (VMAF-NEG) scores for the captured frames. Such generation of the objective metrics enables repeatable assessments of perceived quality and is suited for capturing fine-grained differences introduced by AI super-resolution (AISR) or other stages of the video pipeline. Host device 122 generates aggregated reports reflecting the objective metrics for each of the captured frames from one or more test cycles of DUTs 116. Operation of host device 122 is described in greater detail in conjunction with FIG. 4.

Advantageously, host device 122 provides centralized orchestration of testing operations across multiple instances of DUT 116. In such a centralized orchestration, host device 122 coordinates multiple DUT 116 instances simultaneously rather than executing tests sequentially on a single device. Host device 122 manages distribution of test videos to DUTs 116, monitors the DUT status file for each DUT 116 to track testing state, retrieves captured frames generated by DUTs 116, and performs objective metric analysis. Without such centralized orchestration, users (e.g., operators) are required to manually operate individual DUTs 116, initiate playback, retrieve captured frames, and compute quality metrics separately for each device. Such manual operation can result in a smaller number of tests executed and can introduce error and lower quality data when coordinating large test suites. By contrast, host device 122 manages distribution of tests and coordination of DUT 116 testing states, which results in larger test throughout and reduced error.

Centralized orchestration via host device 122 is further enabled by concurrent, parallel test cycles executed by multiple DUT 116 instances. Such parallel test cycles are enabled through the DUT status files associated with each DUT 116. Because each DUT 116 maintains independent DUT status files, host device 122 can coordinate testing workflows across multiple DUT 116 instances without state conflicts. During parallel execution, different DUT 116 instances can execute different stages of test cycles at the same time. For example, one DUT 116 can receive test videos and reference files from host device 122 while another DUT 116 performs playback of test videos. Host device 122 polls each DUT 116 using the DUT status file to determine device readiness and coordinate test cycles when a DUT 116 becomes available. Such parallel testing reduces the total time required to complete large testing workloads. Users are not required to manually monitor individual DUTs 116 or sequentially execute testing operations on a single DUT 116. Instead, host device 122 provides centralized orchestration, as discussed.

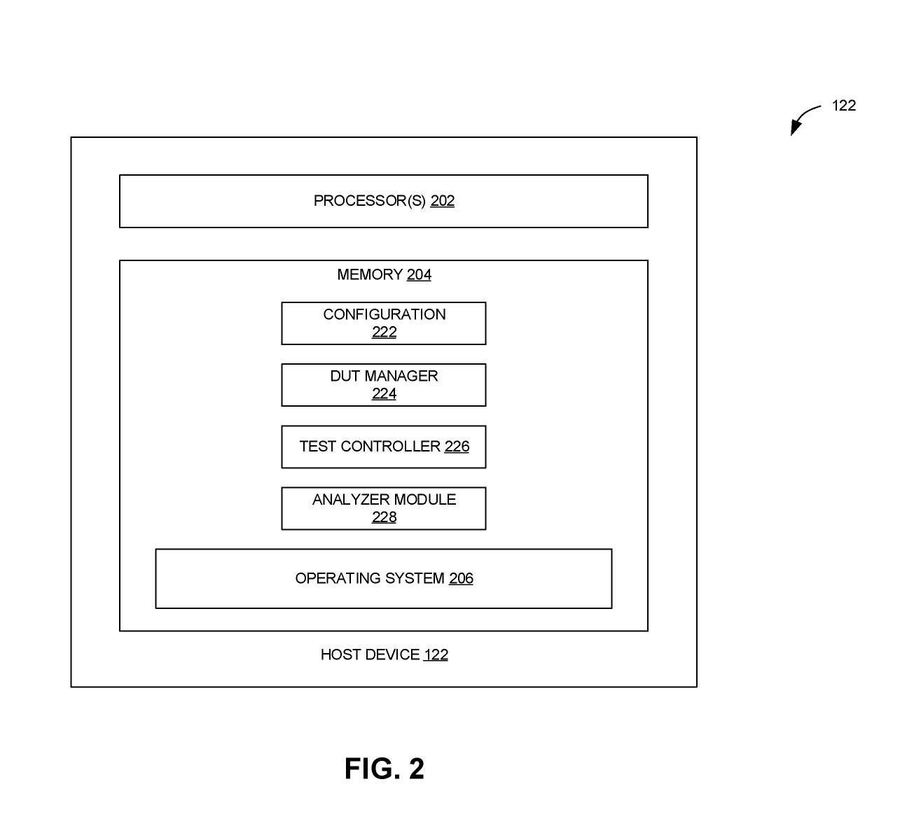

Furthermore, host device 122 can orchestrate execution of the testing workflow across one or more DUTs 116 using configuration metadata stored in a configuration file that identifies DUTs 116. The configuration file determines how host device 122 communicates with each DUT 116 using connectivity information. Such connectivity information includes network addresses associated with each DUT 116 and parameters describing communication schemes used to exchange test data and commands. The configuration file is described in greater detail in conjunction with FIG. 2.

FIG. 2 is a more detailed conceptual illustration of host device 122 of FIG. 1, according to various embodiments. FIG. 2 includes, without limitation, host device 122. Host device 122 includes, without limitation, processor(s) 202 and a memory 204. Memory 204 includes, without limitation, a configuration 222, a DUT manager 224, a test controller 226, an analyzer module 228, and an operating system 206.

Processor(s) 202 can be any instruction execution system, apparatus, or device capable of executing instructions. For example, processor(s) 202 can include a central processing unit (CPU), a graphics processing unit (GPU), a controller, a microcontroller, a state machine, a system on a chip (SoC), or any combination thereof.

Memory 204 stores content for use by processor(s) 202. Memory 204 can be one or more readily available memories, such as random access memory (RAM), read-only memory (ROM), a floppy disk, a hard disk, or any other form of digital storage, local or remote. In some embodiments, storage (not shown) can supplement memory 204. Memory 204 can include any number and type of external memories that are accessible to processor(s) 202. For example, and without limitation, memory 204 can include a Secure Digital Card, an external flash memory, a portable compact disc read-only memory (CD-ROM), an optical storage device, a magnetic storage device, or any suitable combination of the foregoing.

Operating system 206 can be any feasible operating system. For example, operating system 206 can include Linux®, Microsoft Windows®, and/or Android™.

Configuration 222 corresponds to a configuration file that includes configuration information for test cycles used for video quality evaluation. Configuration 222 includes a list of internet protocol (IP) addresses of DUTs 116 and locations of the test videos. In some embodiments, configuration 222 stores additional connection information for each DUT 116. Such connection information describes how host device 122 connects to each DUT 116. Configuration 222 further stores test parameters, where the test parameters can include identifiers of the test videos to be executed, identifiers of the reference files used for comparison, frame capture intervals, additional parameters determining execution of testing, and/or additional metadata used to configure execution of testing. In some embodiments, the reference files are not processed by DUT 116 and are used for objective metric comparison as described in greater detail in conjunction with FIG. 4.

Configuration 222 can also include information identifying stages of a video pipeline at which DUT 116 captures frames, including but not limited to post-decoding stages, post-processing stages, and upscaling stages. Configuration 222 can also instruct DUT 116 to capture frames at one or more of the stages. Configuration 222 enables modification or extension of test cycles by editing configuration 222. Configuration 222 further supports scalability by allowing additional DUT 116 entries to be added to configuration 222. In some embodiments, configuration 222 is implemented as a metadata file such as a JSON metadata file or another type of file.

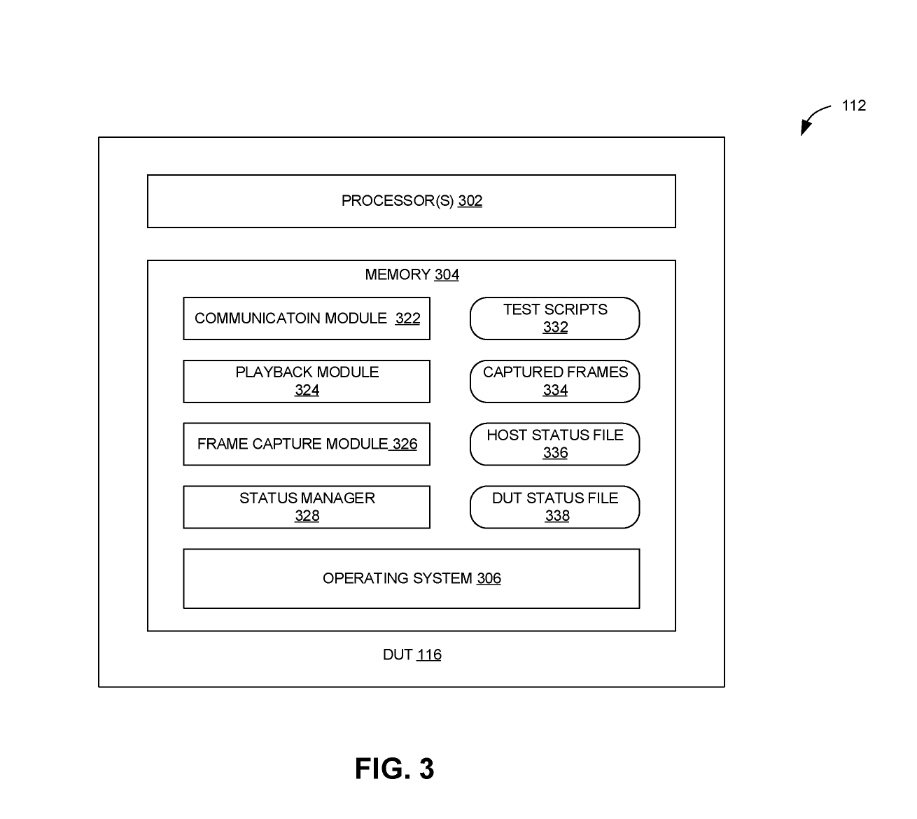

DUT manager 224 monitors a state of one or more DUTs 116 and communicates with one or more DUTs 116. DUT manager 224 monitors each DUT 116 by accessing the DUT status file stored on DUT 116, described in greater detail in conjunction with FIG. 3. DUT manager 224 polls the DUT status file to detect a state of DUT 116 (e.g., the IDLE state, the BUSY state, or the DONE state). In some embodiments, polling is performed by periodically accessing the DUT status file over network 105. DUT manager 224 communicates with each DUT 116 by reading and writing the DUT status file and a host status file located on DUT 116, both of which are described in greater detail in conjunction with FIG. 3.

In some embodiments, DUT manager 224 handles retry logic during exception recovery by repeatedly polling the DUT status file when an expected state transition does not occur within a predefined interval. If a retry threshold is reached without detecting the expected state transition, DUT manager 224 sends a SKIPPING command using the host status file. The SKIPPING command is sent through the host status file to terminate execution of a current test cycle for the affected DUT 116 and proceed to a subsequent test cycle, as described in greater detail in conjunction with FIG. 4. In such a manner, DUT manager 224 prevents a stalled testing cycle from blocking execution of additional tests. Both exception scenarios are discussed in greater detail in conjunction with FIG. 4.

Advantageously, exception recovery allows test cycles to continue when failures occur during execution of a test cycle. Such exception recovery is particularly important when executing large testing workloads across multiple DUTs 116. In general, failure handling can be separated into host-detected failure scenarios and DUT-reported failure scenarios. Exception recovery ensures that failures occurring during communication, playback, or frame capture operations do not cause testing operations to stall.

Failures can occur for several reasons during testing operations. For example, communication failures could occur between host device 122 and DUT 116 over network 105. File-based communication mechanisms can also result in incomplete file transfers, partially written status files, or dropped network connections. In some scenarios, DUT 116 can stall during execution of playback or frame capture operations. In other scenarios, host device 122 can wait indefinitely for a status update when an expected file update is not properly written. To address such scenarios, DUT manager 224 implements skip logic that allows host device 122 to terminate a failed test cycle and proceed with execution of the remaining testing workload. When a failure condition is detected (as described in greater detail in conjunction with FIG. 4), host device 122 skips a current test cycle and initiates execution of a next test cycle. Such an approach prevents testing operations from becoming stuck on a single failed test and ensures that testing operations can continue even when individual tests fail.

Notably, an important design principle enabled by such exception recovery is that failure of one test cycle does not interrupt execution of the testing workflow. By allowing failed test cycles to be skipped while continuing execution of subsequent tests, host device 122 can execute large-scale testing across DUT 116 devices without a failed test cycle compromising additional test cycles.

Test controller 226 coordinates execution of testing operations across one or more DUTs 116. In particular, test controller 226 is a primary controller that maintains runtime activity for the test cycles. As discussed in greater detail in conjunction with FIG. 4, test controller 226 determines test commands to issue to one or more DUTs 116 through DUT manager 224. Test controller 226 determines commands that initiate playback, frame capture operations, and transfer of the captured frame on DUT 116.

Test controller 226 identifies test scripts used for execution of the test cycle and test videos and reference files used during execution of the test cycle. Identification can include ensuring the test videos are available, ensuring the reference files are available, and ensuring the test parameters are available in configuration 222. Identification can further include ensuring that DUT 116 maintains the test script and transmitting the test script when DUT 116 does not maintain the test script. Test controller 226 instructs the test videos, the reference files, and the test scripts to be distributed to DUT 116 using DUT manager 224. After transfer of the captured frames is complete, test controller 226 issues a command to DUT 116 to delete the test videos and the captured frames from DUT 116. In some embodiments, test controller 226 determines sequencing of multiple test cycles so that additional tests are executed once a prior cycle is completed.

Test controller 226 assigns test videos to DUT 116 based on readiness of each DUT 116. Readiness is determined by DUT 116 being in the IDLE state. For example, test controller 226 can assign test videos to one DUT 116 that is in the IDLE state to render while one or more other DUTs 116 are in the BUSY state.

Analyzer module 228 performs computation of objective metrics based on the captured frames and the reference files. Analyzer module 228 compares the captured frames to the reference files and determines objective metrics of video quality. In some embodiments, analyzer module 228 invokes an FFMPEG command to compute VMAF and/or VMAF-NEG scores from the captured frames. For example, analyzer module 228 can process each captured frame by aligning each captured frame to corresponding frames within the reference files. Analyzer module 228 then computes the VMAF and/or VMAF-NEG scores.

In some embodiments, analyzer module 228 aggregates objective metrics across multiple DUTs 116 and test cycles. Analyzer module 228 outputs the objective metrics into a data structure capable of storing such objective metrics for analysis. In some embodiments, the data structure stores the objective metrics for each frame, for each stage, for each test cycle, and for each DUT 116. In some embodiments, the data structure includes a table, database, or comma-separated values file.

Host device 122 enables objective comparison of video processing performance across DUT 116 devices. Because different DUT 116 devices can implement different hardware-accelerated processing pipelines, interaction of host device 122 with multiple DUTs 116 via network 105 allows comparison of decoding quality, upscaling behavior, and/or super-resolution performance across multiple DUTs 116. Host device 122 analyzes captured frames from DUT 116 using objective metrics so that differences between DUTs 116 can be evaluated quantitatively rather than relying on subjective visual inspection.

In one embodiment, comparative testing can involve distributing batches of test videos across multiple identical DUT 116 devices. Host device 122 coordinates execution across DUTs 116 and aggregates results after execution completes. Such a setup accelerates execution of large testing workloads by allowing multiple devices to process videos in parallel. In another embodiment, comparative testing can involve executing a same set of test videos on multiple DUT 116 devices that include different processors, SoCs, and/or hardware architectures. For example, five DUTs 116 implementing different SoCs can each receive the same set of test videos. Host device 122 collects captured frames from each DUT 116 and computes objective metrics that allow direct comparison of video output quality across the different hardware architectures.

FIG. 3 is a more detailed conceptual illustration of DUT 116 of FIG. 1, according to various embodiments. FIG. 3 includes, without limitation, DUT 116. DUT 116 includes, without limitation, processor(s) 302 and a memory 304. Memory 304 includes, without limitation, a communication module 322, a playback module 324, a frame capture module 326, and a status manager 328. Memory 304 further includes, without limitation, test scripts 332, captured frames 334, a host status file 336, and a DUT status file 338.

Processor(s) 302 can be any instruction execution system, apparatus, or device capable of executing instructions. For example, processor(s) 302 can include a central processing unit (CPU), a graphics processing unit (GPU), one or more system on chips (SoCs), a controller, a microcontroller, a state machine, an SoC, or any combination thereof. Notably, different SoC implementations in processor(s) 302 can implement video processing operations differently. For example, different processor(s) 302 can employ different decoding implementations, different upscaling techniques including AI super-resolution, and different postprocessing operations. As a result, video content processed on processor(s) 302 can generate different video quality characteristics.

Memory 304 stores content for use by processor(s) 302. Memory 304 can be one or more readily available memories, such as random access memory (RAM), read-only memory (ROM), a floppy disk, a hard disk, or any other form of digital storage, local or remote. In some embodiments, storage (not shown) can supplement memory 304. Memory 304 can include any number and type of external memories that are accessible to processor(s) 302. For example, and without limitation, memory 304 can include a Secure Digital Card, an external flash memory, a portable compact disc read-only memory (CD-ROM), an optical storage device, a magnetic storage device, or any suitable combination of the foregoing.

Operating system 306 can be any feasible operating system. For example, operating system 306 could include Linux®, Microsoft Windows®, and/or Android™.

Communication module 322 acts as a network interface of DUT 116 and communicates with host device 122 via network 105. Communication module 322 receives the test videos, the reference files, and test scripts 332 with the test parameters as determined by configuration 222. Communication module 322 communicates with host device 122 using file transfer mechanisms and file-based signaling. File transfer mechanisms include transmission and reception of the test videos, test scripts 332, and captured frames 334. File-based signaling includes reading host status file 336 and writing DUT status file 338.

Communication module 322 reads host commands written by host device 122 to host status file 336. Communication module 322 accesses host status file 336 and detects commands including a NOP command, a TESTING command, a RECEIVING command, and a SKIPPING command, as described in greater detail in conjunction with FIG. 4.

In some embodiments, host device 122 pushes test scripts 332 to DUT 116 using file transfer operations, and communication module 322 receives test scripts 332. Communication module 322 enables updating and addition of test scripts 332 without requiring reconfiguration or replacement of software executing on DUT 116.

Communication module 322 further transfers captured frames 334 to host device 122 after playback and frame capture operations are completed. In some embodiments, frame capture module 326 stores captured frames 334 locally on DUT 116 (e.g., in memory 304), and DUT 116 updates DUT status file 338 to the DONE state upon completion of frame capture module 326. Host device 122 then issues the RECEIVING command, after which communication module 322 transfers captured frames 334 to host device 122. In some embodiments, frame transfer is performed using secure copy protocol (SCP) or a similar secure file transfer mechanism.

Communication module 322 additionally supports detecting communication failures. For example, when file communication between DUT 116 and host device 122 fails due to network interruption or incomplete file transfer, communication module 322 can detect the failure, and host device 122 can retry status polling or file transfer operations. Exception recovery procedures can then be executed using status manager 328, including retry operations or skipping of a failed test cycle, as described in greater detail in conjunction with FIG. 4.

Playback module 324 plays the test videos on DUT 116, in some embodiments using hardware acceleration. Playback module 324 initiates playback upon detecting the TESTING command in host status file 336. During execution, playback module 324 renders the test videos and processes the test videos through stages of the video pipeline. In some embodiments, playback module 324 performs hardware decoding of the test videos using decoding capabilities integrated within a system-on-chip of DUT 116. Playback module 324 can perform upscaling operations, including AI super-resolution, to increase spatial resolution of rendered video frames. Playback module 324 can perform postprocessing operations on the test videos after decoding and upscaling stages. At any stage of the video pipeline, playback module 324 can pause. Such pausing enables frame capture module 326 to capture frames and therefore generate captured frames 334.

Frame capture module 326 captures frames from the test videos during playback executed by playback module 324 (e.g., generation of captured frames 334). Frame capture module 326 can capture frames at intervals included in the test parameters included in test scripts 332. The intervals can correspond to frame counts or time intervals during playback. Frame capture module 326 saves captured frames 334 to a local directory on DUT 116 for subsequent transfer to host device 122.

Frame capture module 326 operates in conjunction with playback module 324 during execution of video rendering during playback. In some embodiments, frame capture module 326 communicates with playback module 324 such that playback module 324 temporarily pauses video rendering during playback to enable frame capture module 326 to generate captured frames 334 at specific stages of the video pipeline. Frame capture module 326 signals completion of capture prior to status manager 328 updating DUT status file 338 to the DONE state. In some embodiments, when frames are to be captured at more than one stage of the video pipeline, frame capture module 326 signals to playback module 324 to continue video rendering until a subsequent stage is reached.

Status manager 328 maintains DUT status file 338. Status manager 328 writes IDLE to DUT status file 338 during initialization and updates DUT status file 338 to BUSY upon detecting a TESTING command written by host device 122 in host status file 336. After frame capture module 326 completes generation of captured frames 334, and playback module 324 completes a final stage, status manager 328 updates DUT status file 338 from BUSY to DONE to indicate completion, as described in greater detail in conjunction with FIG. 4. After captured frames 334 are transmitted to host device 122, status manager 328 writes IDLE to DUT status file 338.

Status manager 328 monitors host status file 336 for commands written by host device 122. Status manager 328 responds to the RECEIVING command by transferring captured frames 334 and allowing deletion of the test videos, the reference files, and captured frames 334. Status manager 328 responds to the SKIPPING command by removing the test videos and captured frames 334 associated with a current test cycle, as described in greater detail in conjunction with FIG. 4.

Test scripts 332 contain the test parameters that determine the test videos and how testing operations are executed on DUT 116. For example, test scripts 332 could instruct DUT 116 when to capture frames, identify stages of the video pipeline at which frames should be captured, and determine how many frames should be captured during playback of the test videos.

For example, test scripts 332 could instruct playback module 324 to initiate playback of the test videos and/or instruct frame capture module 326 to generate captured frames 334 at specified intervals or stages of the video pipeline. Test scripts 332 can also determine conditions under which DUT 116 signals completion of frame capture and transitions of DUT 116 status (e.g., from the BUSY state to the DONE state).

Captured frames 334 correspond to image frames extracted during playback of the test videos. In some embodiments, captured frames 334 correspond to frames captured at one or more stages of a video pipeline. Captured frames 334 are generated at predefined frame capture intervals specified by configuration 222 and subsequently through test scripts 332. Captured frames 334 are transmitted from DUT 116 to host device 122 using network 105. Analyzer module 228 compares captured frames 334 with corresponding reference files to determine objective metrics representing video quality.

Host status file 336 includes a command issued by host device 122 to DUT 116 and stored on DUT 116. In some embodiments, host status file 336 includes a single string representing the command. In some embodiments, host status file 336 includes a single character representing the command. In some embodiments, commands include the NOP command, the TESTING command, the RECEIVING command, and the SKIPPING command.

Host status file 336 is updated using host device 122 and specifically DUT manager 224, as determined by test controller 226. Test controller 226 determines a command to be issued during execution of testing operations, and DUT manager 224 performs write operations that update host status file 336 on DUT 116. On DUT 116, communication module 322 reads host status file 336 to detect the command. After command detection, status manager 328 interprets the command and updates DUT status file 338. In some embodiments, host status file 336 is in the form of /home/user/status/status_<DUT_IP>_HOST.txt.

DUT status file 338 corresponds to a test state of DUT 116. DUT status file 338 is accessed remotely by host device 122 via network 105. DUT status file 338 includes a value representing the test state. In some embodiments, DUT status file 338 includes a single string representing the test state. In some embodiments, DUT status file 338 includes a single character representing the test state. In some embodiments, DUT status file 338 includes the test state, where test states include IDLE, BUSY, and DONE. In some embodiments, DUT status file 338 is in the form of /home/user/status/status_<DUT_IP>_DUT.txt in order to avoid collision during file updating operations.

Advantageously, host device 122 can execute multiple testing workflows concurrently across different DUTs 116. Test controller 226 and DUT manager 224 maintain awareness of the test state of each DUT 116 by polling DUT status file 338. Because each DUT 116 maintains independent status files, host device 122 can coordinate testing workflows for multiple DUTs 116 without state conflicts.

For example, a series of test cycles could include 100 test videos and five identical DUT 116 instances. Host device 122 could divide the 100 test videos into five batches and assign each batch to a different DUT 116 so that the batches execute in parallel. In another example, five different DUTs 116 each receive the same set of 100 test videos, enabling comparison of results generated by the DUTs 116.

FIG. 4 illustrates a sequence diagram 400 for a test cycle, including transmitting and testing test videos, capturing frames, and aggregating the captured frames, according to some embodiments. Although the method steps are described in conjunction with the systems of FIGS. 1-4, persons skilled in the art will understand that any system configured to perform the method steps, in any order, is within the scope of the present disclosure.

DUT 404 represents an instance or implementation of DUT 116 during the test cycle associated with sequence diagram 400. Host device 402 represents an instance or implementation of host 122 during the test cycle associated with sequence diagram 400.

As shown in FIG. 4, sequence diagram 400 begins at step 408, where test controller 226 issues a write instruction of the NOP command in host status file 336. DUT manager 224 performs the write operation to host status file 336 remotely via network 105. The NOP command indicates that no operation is currently requested from DUT 404 and establishes a neutral starting state before execution of a test cycle. Status manager 328 uses communication module 322 and monitors host status file 336 to detect command changes issued by host device 402. While host status file 336 includes the NOP command, DUT 404 waits for a subsequent command initiating testing operations.

At step 410, test controller 226 identifies the test videos, the reference files, and test scripts 332 for the test cycle. Test controller 226 performs the identification using information stored in configuration 222. Based on configuration 222, test controller 226 selects one or more of the test videos to execute. Test controller 226 identifies the reference files for the test videos. In some embodiments, test controller 226 also determines test scripts 332 used in the test cycle, including retrieving test scripts 332 from storage, selecting one or more test scripts 332 and/or preparing test scripts 332. Such a determination can also include frame capture intervals or capture stages for the test cycle if unspecified and can include the determination in test scripts 332.

At step 412, DUT manager 224 waits for the IDLE state in DUT status file 338. DUT manager 224 polls DUT status file 338 remotely via network 105 by repeatedly reading DUT status file 338 until the IDLE state is detected. The IDLE state indicates that DUT 404 is ready to receive the test videos and that no testing operation is currently executing on DUT 404.

At step 414, status manager 328 writes IDLE in DUT status file 338. Status manager 328 writes IDLE during initialization of DUT 404 or after completion of a previous test cycle. The write operation of IDLE indicates that DUT 404 is ready to receive testing instructions from host device 402. In some embodiments, the write operation can occur before step 410 when DUT 404 is initialized or before step 412 when DUT manager 224 begins polling DUT status file 338.

At step 416, DUT manager 224 reads IDLE in DUT status file 338 stored on DUT 404. DUT manager 224 performs the read operation remotely via network 105 and confirms that DUT 404 has entered the IDLE state.

At step 418, DUT manager 224 transmits the test videos and the reference files to DUT 404. DUT manager 224 then initiates transmission of the test videos and, in some embodiments, the reference files to DUT 404 over network 105. Communication module 322 on DUT 404 receives the transmitted files and stores the transmitted files locally on DUT 404.

At step 420, DUT manager 224 transmits test scripts 332 to DUT 404 when DUT 404 does not store test scripts 332. DUT manager 224 initiates transmission of test scripts 332 over network 105. Such a step is optional, as in some embodiments DUT 404 can already store test scripts 332. Communication module 322 receives the transmitted test scripts 332 and stores test scripts 332 on DUT 404.

At step 422, status manager 328 waits for the TESTING command in host status file 336. Status manager 328 repeatedly reads host status file 336 to detect the TESTING command written by host device 402. While host status file 336 does not contain the TESTING command, DUT 404 waits. Such a waiting mechanism ensures synchronization between host device 402 and DUT 404 before execution of subsequent steps.

At step 424, DUT manager 224 writes TESTING in host status file 336. Communication module 322 on DUT 404 detects the TESTING command in host status file 336. Status manager 328 interprets the TESTING command and proceeds to a next step.

At step 426, status manager 328 writes BUSY in DUT status file 338. Status manager 328 writes BUSY after detecting the TESTING command in host status file 336. Writing BUSY indicates that DUT 404 is actively executing the test cycle.

At step 428, DUT manager 224 reads BUSY in DUT status file 338. DUT manager 224 performs the read operation remotely via network 105 as part of status polling performed by host device 402. Such a read operation allows host device 402 to confirm that testing operations have started and prevents host device 402 from retransmitting commands that could otherwise initiate duplicate execution of the test cycle.

At step 430, host device 402 optionally performs exception recovery when execution of the test cycle fails. Failures can occur when the TESTING command or the test videos are not properly received by DUT 404, causing DUT 404 to remain in the IDLE state while host device 402 does not detect the BUSY state in DUT status file 338. In such a scenario, host device 402 has written the TESTING command in host status file 336, but DUT 404 does not transition to BUSY during status polling performed by DUT manager 224. Such failures can result from file-based communication errors, including network interruptions, incomplete file transfers, or partial file writes that prevent proper command execution. In some embodiments, failures can also occur when DUT 404 does not properly receive the TESTING command or an associated test video transmitted by host device 402. Without exception recovery, such failures could cause the test cycle to fail and risk failure of subsequent test cycles as well.

To address failure conditions, DUT manager 224 repeatedly polls DUT status file 338 and retries test initiation operations for a configurable number of attempts. In some embodiments, host device 402 reattempts testing by retransmitting the TESTING command or an associated test video and continues monitoring DUT status file 338 for a transition to BUSY. For example, host device 402 could retry the operation three times while waiting for DUT 404 to transition from the IDLE state to the BUSY state. If the retry limit is reached and DUT status file 338 does not indicate BUSY, host device 402 determines that the test cycle has failed. DUT manager 224 then writes the SKIPPING command in host status file 336. Upon detecting the SKIPPING command, status manager 328 on DUT 404 removes the test video and any captured frames associated with the failed test cycle and returns DUT 404 to the IDLE state. Host device 402 then proceeds to the next test cycle in the testing workflow. In such a manner, failure of a single test video does not interrupt execution of remaining testing cycles. In some embodiments, the SKIPPING command is used for both host-detected failures and failures detected by DUT 404, thereby terminating the failed cycle and allowing execution of subsequent tests to continue.

At step 432, playback module 324 executes video rendering and playback of the test videos, and frame capture module 326 captures frames on DUT 404. Playback occurs through the video pipeline. During playback, frame capture module 326 captures frames from the test videos at intervals determined in test scripts 332, therefore generating captured frames 344.

At step 434, status manager 328 writes DONE in DUT status file 338 stored on DUT 404. Status manager 328 performs such a write operation after execution of playback module 324 and frame capture module 326 completes. Writing DONE indicates that playback has finished, frame capture has completed, and captured frames are available for retrieval by host device 402.

At step 438, DUT manager 224 reads DONE in DUT status file 338. DUT manager 224 performs the read operation by polling DUT status file 338 remotely via network 105. Detection of the DONE state indicates that playback and frame capture operations executed by DUT 404 have been completed.

At step 440, host device 402 optionally performs exception recovery when DUT 404 fails to complete a test cycle after entering the BUSY state. In some embodiments, DUT 404 can remain in the BUSY state while host device 402 does not read DONE in DUT status file 338. Such a condition can occur when execution of playback or frame capture operations fails, when file communication errors prevent proper status updates, or when postprocessing operations (e.g., upscaling) executed as part of the video pipeline fail. To detect such a condition, DUT manager 224 repeatedly polls DUT status file 338 via network 105 for a configurable number of retry attempts while waiting for DUT 404 to transition from BUSY to DONE. In some embodiments, the number of retry attempts is configurable and can include a predetermined number of retries such as three attempts. If a limit of retry attempts is reached and DUT status file 338 does not indicate DONE, host device 402 determines that the test cycle has failed. DUT manager 224 then writes the SKIPPING command in host status file 336 to terminate execution of the test cycle. Upon detecting the SKIPPING command, status manager 328 on DUT 404 removes the test videos and captured frames associated with the test cycle and updates DUT status file 338 to IDLE. In such a manner, failure of a particular test video or test cycle does not interrupt execution of the remaining testing workflow. Host device 402 then proceeds to the next test cycle.

At step 442, status manager 328 waits for the RECEIVING command in host status file 336. DUT 404 waits until the RECEIVING command is detected and remains in the DONE state while waiting. The RECEIVING command indicates that host device 402 is prepared to copy captured frames from DUT 404 and that the workflow can proceed to frame transfer.

At step 444, DUT manager 224 writes RECEIVING in host status file 336. Test controller 226 determines that DUT 404 has completed frame capture operations based on polling of DUT status file 338 performed by DUT manager 224. DUT manager 224 then writes RECEIVING in host status file 336 remotely via network 105. Writing RECEIVING signals DUT 404 that host device 402 will retrieve captured frames generated during the test cycle. Detection of the RECEIVING command allows DUT 404 to permit transfer of captured frames and prepare for cleanup operations after the frame transfer completes.

At step 446, communication module 322 copies captured frames 334 from DUT 404 to host device 402. Communication module 322 initiates transfer of captured frames 334 after detecting the RECEIVING command in host status file 336. The copy occurs over network 105 using file transfer mechanisms such as secure copy protocol (SCP) or another secure file transfer mechanism. Host device 402 receives captured frames 334 and stores captured frames 334 for subsequent analysis by analyzer module 228. In some embodiments, host device 402 can initiate retrieval of captured frames 334. For example, DUT manager 224 can initiate a file transfer operation to retrieve captured frames 334 from DUT 404.

At step 448, DUT manager 224 sends a request to delete the test videos and the reference files stored on DUT 404. Test controller 226 determines that captured frames 334, the test videos, and the reference files stored on DUT 404 are no longer required after successful transfer of captured frames 334. DUT manager 224 transmits the deletion request to DUT 404 via network 105. The request instructs DUT 404 to remove the test videos, the reference files, and captured frames 334 associated with the test cycle.

At step 450, communication module 322 receives the deletion request transmitted from host device 402, and status manager 328 deletes the test videos, the reference files, and captured frames 334. After deleting the files, DUT 404 returns to the IDLE state and proceeds to step 414 to signal readiness for execution of a subsequent test cycle.

At step 452, analyzer module 228 analyzes captured frames 334 to generate objective metrics. Analyzer module 228 retrieves captured frames 334 received from DUT 404 and the reference files associated with the test videos. Analyzer module 228 generates objective metrics representing visual quality differences between captured frames 334 and the reference files. In some embodiments, the objective metrics include VMAF scores and VMAF-NEG scores computed for each captured frame sequence using one or more scoring techniques.

At step 454, test controller 226 determines whether more tests remain to be executed. In some embodiments, test controller 226 performs such a decision based on information stored in configuration 222. If additional tests remain, host device 402 proceeds to execute another test cycle beginning with identification of the next test videos at step 410. In some embodiments, host device 402 can assign the next test video either to the same DUT 404 that completed the test cycle or to a different DUT 404 that is currently in an IDLE state. If no additional tests remain, the workflow proceeds to aggregation and reporting of analysis results.

At step 456, analyzer module 228 aggregates and reports objective metrics generated from one or more test cycles. Analyzer module 228 aggregates results across objective metrics from multiple DUT 404 instances and/or multiple test cycles, when applicable. The aggregated results can be stored in a data structure configured to store objective metrics associated with the testing workflow. Aggregation can include summarizing the objective metrics and/or organizing the objective metrics according to DUT 404, the test video, or the stage of the video pipeline. The report enables consistent and repeatable video quality evaluation across DUTs 116. In some embodiments, after step 456, host device 402 can execute step 408 to indicate that no operation is currently requested from DUT 404.

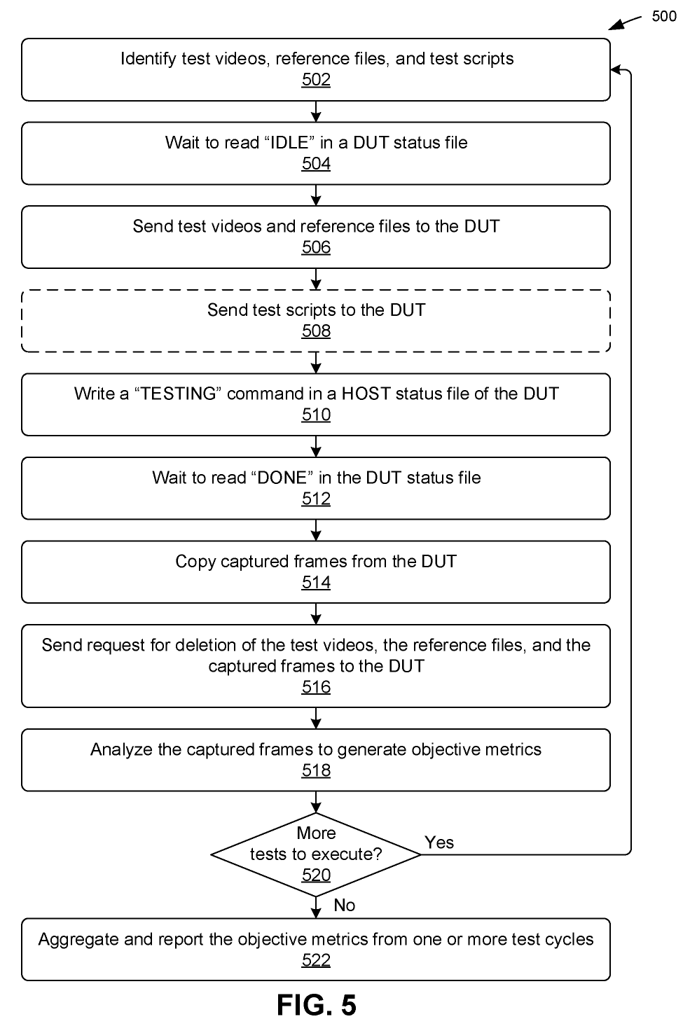

FIG. 5 illustrates a flow diagram of a method 500 for executing a test cycle and generating objective metrics by host device 122, according to various embodiments. Although the method steps are described in conjunction with the systems of FIGS. 1-4, persons skilled in the art will understand that any system configured to perform the method steps, in any order, is within the scope of the present disclosure.

As shown in FIG. 5, the method 500 begins at step 502, where test controller 226 identifies test videos, reference files, and test scripts 332 to be used for a testing cycle. The identification is based on configuration 222, as described in FIGS. 1-4. At step 504, DUT manager 224 waits to read IDLE in DUT status file 338. Detection of the IDLE state indicates that DUT 116 is ready to receive testing instructions, and no active test execution is occurring, as described in FIGS. 1-4.

At step 506, DUT manager 224 sends test videos and reference files to DUT 116. The test videos and the reference files are transferred over network 105 and received by communication module 322 on DUT 116 for subsequent playback and evaluation, as described in FIGS. 1-4. At step 508, DUT manager 224 optionally sends test scripts 332 to DUT 116 when test scripts 332 are not already present on DUT 116, as described in FIGS. 1-4.

At step 510, DUT manager 224 writes the TESTING command in host status file 336 associated with DUT 116. The TESTING command signals DUT 116 to begin executing playback and frame capture operations according to the assigned test configuration, as described in FIGS. 1-4. At step 512, DUT manager 224 waits to read DONE from DUT status file 338. Detection of DONE indicates that playback and frame capture operations have completed on DUT 116, as described in FIGS. 1-4.

At step 514, communication module 322 transfers captured frames 334 from DUT 116 to host device 402. In some embodiments, host device 402 can initiate the transfer by retrieving the frames using file transfer mechanisms over network 105, as described in FIGS. 1-4. At step 516, DUT manager 224 sends a request for deletion of the test videos, the reference files, and captured frames 334 stored on DUT 116. Such an operation frees resources on DUT 116 before a next test cycle begins, as described in FIGS. 1-4.

At step 518, analyzer module 228 analyzes the captured frames to generate objective metrics associated with the test videos. In some embodiments, analyzer module 228 computes VMAF scores and VMAF-NEG scores to quantify visual quality differences between captured frames 334 and corresponding reference frames, as described in FIGS. 1-4. At step 520, test controller 226 determines whether additional tests remain to be executed. If additional tests remain, method 500 proceeds to step 502 and initiates another testing cycle, as described in FIGS. 1-4. Otherwise, method 500 proceeds to step 522.

At step 522, analyzer module 228 aggregates and reports the objective metrics generated across one or more testing cycles. The report enables comparison of video quality evaluation across multiple DUTs 116 and test cycles, as described in FIGS. 1-4.

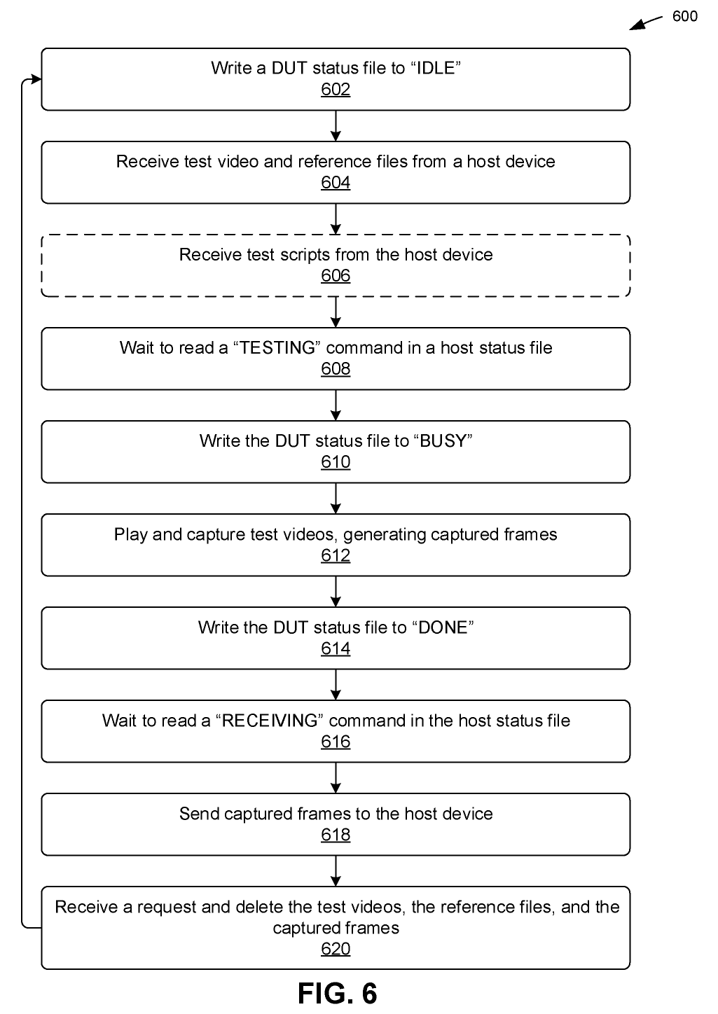

FIG. 6 illustrates a flow diagram of a method 600 for executing a test cycle by DUT 116, according to various embodiments. Although the method steps are described in conjunction with the systems of FIGS. 1-4, persons skilled in the art will understand that any system configured to perform the method steps, in any order, is within the scope of the present disclosure.

As shown in FIG. 6, the method 600 begins at step 602, where status manager 328 writes IDLE in DUT status file 338. The IDLE state indicates that DUT 404 is available to receive testing instructions and is not currently executing a test cycle, as described in FIGS. 1-4. At step 604, communication module 322 receives a test video and reference files from host device 122. The files are transmitted over network 105 and stored locally on DUT 116 for execution during the test cycle, as described in FIGS. 1-4.

At step 606, communication module 322 optionally receives test scripts 332 from host device 122 if DUT 116 does not have necessary test scripts 332 for the test cycle, as described in FIGS. 1-4. At step 608, status manager 328 waits to read a TESTING command in host status file 336. Detection of the TESTING command indicates that host device 122 has initiated the test cycle and that DUT 404 should begin execution, as described in FIGS. 1-4.

At step 610, status manager 328 writes BUSY in DUT status file 338. The BUSY state indicates to host device 402 that DUT 404 has begun executing playback and frame capture operations, as described in FIGS. 1-4. At step 612, playback module 324 plays the test videos, and frame capture module 326 captures frames and generates captured frames 334. Playback occurs through video rendering stages of the video pipeline, and frame capture can occur at one or more stages of the video processing pipeline, as described in FIGS. 1-4.

At step 614, status manager 328 writes DONE in DUT status file 338. The DONE state indicates that playback and frame capture operations have completed and that captured frames 334 are ready for retrieval by host device 402, as described in FIGS. 1-4.

At step 616, communication module 322 waits to read the RECEIVING command in host status file 336. Detection of the RECEIVING command indicates that host device 402 is prepared to retrieve captured frames 334 from DUT 116, as described in FIGS. 1-4. At step 618, communication module 322 sends captured frames 334 to host device 402. Captured frames 334 can be transferred using secure file transfer mechanisms over network 105, as described in FIGS. 1-4.

At step 620, communication module 322 receives a request from host device 402 and deletes the test videos, the reference files, and captured frames 334 stored on DUT 116. Then DUT 116 proceeds to step 602 and returns to an IDLE state for a subsequent test cycle, as described in FIGS. 1-4.

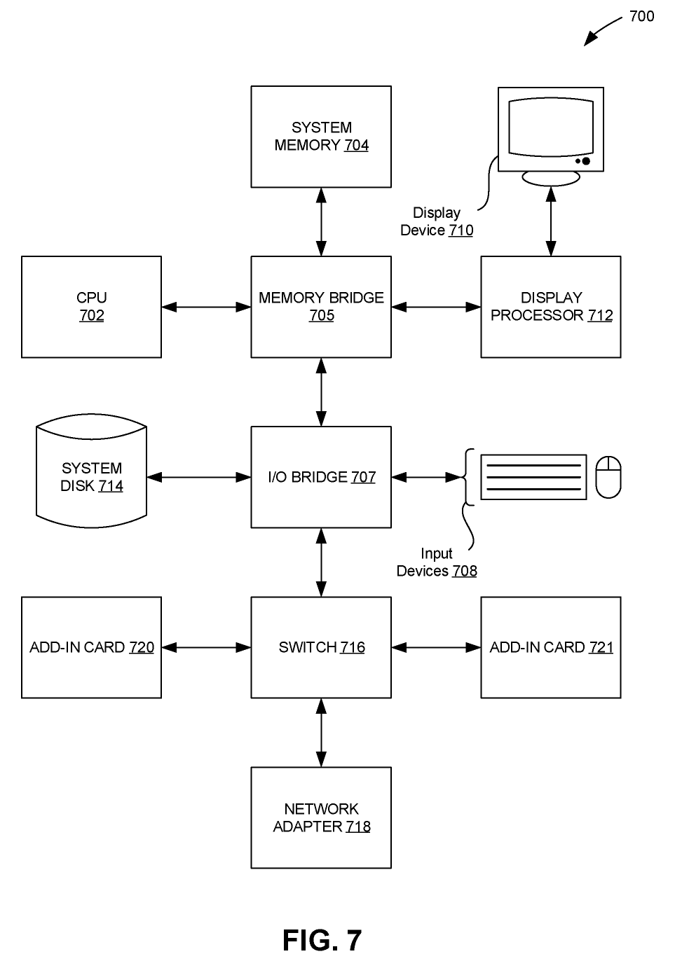

FIG. 7 is a more detailed illustration of a computing device that can implement the functionalities of any of the entities illustrated in FIG. 1, according to various embodiments. FIG. 7 in no way limits, or is intended to limit, the scope of the various embodiments. In various implementations, system 700 may be an augmented reality, virtual reality, or mixed reality system or device; a personal computer; a video game console; a personal digital assistant; a mobile phone; a mobile device; or any other device suitable for practicing the various embodiments. Further, in various embodiments, any combination of two or more systems 700 may be coupled together to practice one or more aspects of the various embodiments.

As shown, system 700 includes a central processing unit (CPU) 702 and a system memory 704 communicating via a bus path that may include a memory bridge 705. CPU 702 includes one or more processing cores and, in operation, CPU 702 is the master processor of system 700 and controls and coordinates operations of other system components. System memory 704 stores software applications and data for use by CPU 702. CPU 702 runs software applications and, optionally, an operating system. Memory bridge 705, which may be, for example, a Northbridge chip, is connected via a bus or other communication path (e.g., a HyperTransport link) to an I/O (input/output) bridge 707. I/O bridge 707, which may be, for example, a Southbridge chip, receives user input from one or more user input devices 708 (e.g., a keyboard, mouse, joystick, digitizer tablets, touch pads, touch screens, still or video cameras, motion sensors, and/or microphones) and forwards the user input to CPU 702 via memory bridge 705.

A display processor 712 is coupled to memory bridge 705 via a bus or other communication path (e.g., a PCI Express, Accelerated Graphics Port, or HyperTransport link). In one embodiment, display processor 712 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 704.

Display processor 712 periodically delivers pixels to a display device 710 (e.g., a screen or conventional CRT, plasma, OLED, SED, or LCD based monitor or television). Additionally, display processor 712 may output pixels to film recorders adapted to reproduce computer-generated images on photographic film. Display processor 712 can provide display device 710 with an analog or digital signal. In various embodiments, one or more of the various graphical user interfaces set forth in FIG. 3 are displayed to one or more users via display device 710, and one or more users can input data into and receive visual output from the various graphical user interfaces.

A system disk 714 is also connected to I/O bridge 707 and may be configured to store content, applications, and data for use by CPU 702 and display processor 712. System disk 714 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 716 provides connections between I/O bridge 707 and other components such as a network adapter 718 and various add-in cards 720 and 721. Network adapter 718 allows system 700 to communicate with other systems via an electronic communications network and may include wired or wireless communication over local area networks and wide area networks such as the Internet.

Other components (not shown), including USB or other port connections, film recording devices, and the like, may also be connected to I/O bridge 707. For example, an audio processor may be used to generate analog or digital audio output from instructions and/or data provided by CPU 702, system memory 704, or system disk 714. Communication paths interconnecting the various components in FIG. 7 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 712 incorporates circuitry optimized for graphics and video processing, including, for example, video output circuitry, and constitutes a graphics processing unit (GPU). In another embodiment, display processor 712 incorporates circuitry optimized for general-purpose processing. In yet another embodiment, display processor 712 may be integrated with one or more other system elements, such as memory bridge 705, CPU 702, and I/O bridge 707, to form a system on chip (SoC). In still further embodiments, display processor 712 is omitted and software executed by CPU 702 performs the functions of display processor 712.

Pixel data can be provided to display processor 712 directly from CPU 702. In some embodiments, instructions and/or data representing a scene are provided to a render farm or a set of server computers, each similar to system 700, via network adapter 718 or system disk 714. The render farm generates one or more rendered images of the scene using the provided instructions and/or data. The rendered images may be stored on computer-readable media in a digital format and, optionally, returned to system 700 for display. Similarly, stereo image pairs processed by display processor 712 may be output to other systems for display, stored on system disk 714, or stored on computer-readable media in a digital format.

Alternatively, CPU 702 provides display processor 712 with data and/or instructions defining the desired output images, from which display processor 712 generates the pixel data of one or more output images, including characterizing and/or adjusting the offset between stereo image pairs. The data and/or instructions defining the desired output images can be stored in system memory 704 or graphics memory within display processor 712. In an embodiment, display processor 712 includes 3D rendering capabilities for generating pixel data for output images from instructions and data defining the geometry, lighting, shading, texturing, motion, and/or camera parameters for a scene. Display processor 712 can further include one or more programmable execution units capable of executing shader programs, tone mapping programs, and the like.

Further, in other embodiments, CPU 702 or display processor 712 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments, any of the operations and/or functions described herein can be performed by CPU 702, display processor 712, or one or more other processing devices, or any combination of the different processors.

CPU 702, the render farm, and/or display processor 712 can employ any surface or volume rendering technique known in the art to generate one or more rendered images from the provided data and instructions, including rasterization, scanline rendering, REYES or micropolygon rendering, ray casting, ray tracing, image-based rendering techniques, and/or combinations of the techniques and any other rendering or image processing techniques known in the art.

In other contemplated embodiments, system 700 may be a robot or robotic device and may include CPU 702 and/or other processing units or devices and system memory 704. In such embodiments, system 700 may or may not include other elements shown in FIG. 7. System memory 704 and/or other memory units or devices in system 700 may include instructions that, when executed, cause the robot or robotic device represented by system 700 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 704 is connected to CPU 702 directly rather than through a bridge, and other devices communicate with system memory 704 via memory bridge 705 and CPU 702. In other alternative topologies, display processor 712 is connected to I/O bridge 707 or directly to CPU 702, rather than to memory bridge 705. In still other embodiments, I/O bridge 707 and memory bridge 705 might be integrated into a single chip. The particular components shown herein are optional; for instance, any number of add-in cards or peripheral devices might be supported. In some embodiments, switch 716 is eliminated, and network adapter 718 and add-in cards 720 and 721 connect directly to I/O bridge 707.

In sum, techniques are disclosed for performing automated video quality evaluations across multiple devices, including devices under test (DUTs). In some embodiments, a host device coordinates execution of test cycles on one or more DUTs, where each test cycle includes providing test videos and corresponding reference files to a DUT, causing the DUT to execute playback of the test videos, capturing frames generated during playback, retrieving the captured frames from the DUT, and analyzing the captured frames relative to the reference files to generate objective video quality metrics. In some embodiments, the objective video quality metrics include video multi-method assessment fusion (VMAF) scores and/or VMAF-no enhancement gain (VMAF-NEG) scores.

In some embodiments, the host device communicates with each DUT using a file-based coordination scheme that includes a host status file and a DUT status file. The DUT status file can indicate a testing state of the DUT, such as IDLE, BUSY, or DONE, and the host status file can indicate a command for the DUT, such as NOP, TESTING, RECEIVING, or SKIPPING. The host device can identify a DUT in the IDLE state, transmit test content for a test cycle to the DUT, and issue the TESTING command. In response, the DUT can update the DUT status file to BUSY, execute playback and frame capture operations, and then update the DUT status file to DONE when captured frames are ready for transfer. After detecting the DONE state, the host device can issue the RECEIVING command, retrieve the captured frames, request deletion of test-cycle files from the DUT, and return the DUT to an IDLE state for a subsequent test cycle.

In some embodiments, the DUT executes playback using one or more video-processing stages of a video pipeline, including decoding, post-processing, upscaling, and/or AI-based super-resolution. Frames can be captured at one or more specified stages of the video pipeline according to configuration data and/or one or more test scripts. The host device can analyze the captured frames relative to corresponding reference files and can aggregate resulting objective metric data across captured frames, stages, test cycles, and DUTs.

In some embodiments, the host device maintains configuration data identifying DUTs, connectivity information for the DUTs, test videos, reference files, frame-capture parameters, and pipeline stages for frame capture. The host device can assign test videos to DUTs based on DUT readiness and can coordinate multiple DUTs concurrently while maintaining separate status files for respective DUTs. In some embodiments, when an expected state transition does not occur, the host device performs exception recovery that includes retry operations and, if appropriate, issuance of a SKIPPING command to terminate a current test cycle and proceed to another test cycle. The disclosed techniques can be implemented in on-premises environments, network-based environments, cloud-based environments, or combinations thereof.

At least one technical advantage of the disclosed techniques relative to the prior art is that the disclosed techniques reduce or eliminate manual operator intervention in execution of a testing workflow. For example, the disclosed techniques enable automated execution of multiple tests in parallel across multiple devices under test (DUTs), and further enable sequential execution of successive test cycles without requiring operator interaction between tests or test cycles. As a result, the disclosed techniques reduce idle time between test operations, reduce synchronization delays associated with manual coordination, and reduce operator-induced variability in test execution. In this manner, the disclosed techniques improve utilization of computing and DUT resources and increase automated test-execution throughput relative to conventional techniques.

Another technical advantage of the disclosed techniques relative to the prior art is that the disclosed techniques enable centralized orchestration of test execution, for example through a host machine that coordinates operation of multiple DUTs. Such centralized orchestration enables consistent scheduling, command issuance, data collection, and file handling across DUTs according to a common control scheme. As a result, the disclosed techniques improve repeatability and reproducibility of test execution, enable objective and consistent verification using common evaluation criteria, and reduce errors arising from inconsistent local execution behavior or non-uniform data handling. Further, use of a consistent communication scheme for test progress information, test data, and files between the DUTs and the host machine improves reliability of inter-device coordination and promotes generation of more consistent and technically reliable test results.

Another technical advantage of the disclosed techniques relative to the prior art is that the disclosed techniques are scalable and adaptable across differing test environments and video-processing configurations. For example, the disclosed techniques enable addition, removal, or modification of DUTs participating in a testing workflow without requiring redesign of the overall orchestration framework. The disclosed techniques further support video quality evaluation at multiple stages of a video-processing pipeline, including post-decoding, post-processing, and/or upscaling stages, such that quality analysis can be selectively performed at different processing points within one or more DUTs. This improves flexibility of the testing architecture while preserving a common automated control and data-collection framework.

Yet another technical advantage of the disclosed techniques relative to the prior art is that the disclosed techniques can be deployed in different computing environments, including on-premises architectures and cloud-based environments in which communication with DUTs occurs over a network such as the Internet. Accordingly, the disclosed techniques enable a common orchestration and monitoring framework to be used across distributed computing environments, which improves portability of the testing system and allows technically consistent test control, status monitoring, and result collection across heterogeneous infrastructure.

These technical advantages represent one or more technological advancements over prior art approaches.
1. In some embodiments, a computer-implemented method for performing distributed video quality evaluations comprises: obtaining configuration data associated with a plurality of devices under test (DUTs) and a plurality of test cycles; assigning the plurality of test cycles to available DUTs of the plurality of DUTs; obtaining, from the plurality of DUTs, captured frames generated during execution of the plurality of test cycles; analyzing the captured frames relative to reference data to generate objective video quality metrics; aggregating the objective video quality metrics across at least a subset of the plurality of test cycles to generate aggregated objective video quality metrics; and performing at least one action based at least on the aggregated objective video quality metrics.
2. The computer-implemented method of clause 1, wherein the configuration data includes connectivity information associated with the plurality of DUTs.
3. The computer-implemented method of any of clauses 1-2, wherein the configuration data includes frame-capture parameters associated with the plurality of test cycles.
4. The computer-implemented method of any of clauses 1-3, wherein the configuration data includes obtaining stage information that identifies one or more stages of a video-processing pipeline at which the captured frames are to be generated.
5. The computer-implemented method of any of clauses 1-4, wherein assigning the plurality of test cycles includes assigning a first test cycle to a first DUT in response to detecting, via a DUT status file associated with the first DUT, that the first DUT is in an IDLE state.
6. The computer-implemented method of any of clauses 1-5, wherein assigning the plurality of test cycles further includes assigning a second test cycle to a second DUT while the first DUT remains assigned to the first test cycle.
7. The computer-implemented method of any of clauses 1-6, wherein obtaining at least a portion of the captured frames includes causing a transfer of the portion of the captured frames from a DUT of the plurality of DUTs after detecting, via a DUT status file associated with the DUT, a transition of the DUT to a DONE state.
8. The computer-implemented method of any of clauses 1-7, wherein a first portion of the captured frames are obtained at a post-decoding stage of a video-processing pipeline and a second portion of the captured frames are obtained at an upscaling stage of the video-processing pipeline.
9. The computer-implemented method of any of clauses 1-8, wherein analyzing the captured frames includes generating video multi-method assessment fusion (VMAF) scores.
10. The computer-implemented method of any of clauses 1-9, wherein analyzing the captured frames further includes generating one or more of VMAF-no enhancement gain (VMAF-NEG) scores or VMAF scores.
11. In some embodiments, one or more non-transitory computer readable media store instructions that, when executed by one or more processors, cause the one or more processors to perform distributed video quality evaluations, by performing the operations of: obtaining configuration data associated with a plurality of devices under test (DUTs) and a plurality of test cycles; assigning the plurality of test cycles to available DUTs of the plurality of DUTs; obtaining, from the plurality of DUTs, captured frames generated during execution of the plurality of test cycles; analyzing the captured frames relative to reference data to generate objective video quality metrics; aggregating the objective video quality metrics across at least a subset of the plurality of test cycles to generate aggregated objective video quality metrics; and performing at least one action based at least on the aggregated objective video quality metrics.
12. The one or more non-transitory computer readable media of clause 11, wherein aggregating the objective video quality metrics includes organizing the objective video quality metrics according to at least one of a DUT identifier, a test cycle identifier, a frame identifier, or a video-processing stage identifier.
13. The one or more non-transitory computer readable media of any of clauses 11-12, wherein the at least one action includes generating a report based at least on the aggregated objective video quality metrics.
14. The one or more non-transitory computer readable media of any of clauses 11-13, wherein the at least one action includes comparing a first objective video quality of a first DUT to a second objective video quality of a second DUT based at least on the aggregated objective video quality metrics.
15. The one or more non-transitory computer readable media of any of clauses 11-14, wherein the configuration data includes connectivity information associated with the plurality of DUTs.
16. The one or more non-transitory computer readable media of any of clauses 11-15, wherein the configuration data includes frame-capture parameters associated with the plurality of test cycles.
17. The one or more non-transitory computer readable media of any of clauses 11-16, wherein the configuration data includes obtaining stage information that identifies one or more stages of a video-processing pipeline at which the captured frames are to be generated.
18. The one or more non-transitory computer readable media of any of clauses 11-17, wherein assigning the plurality of test cycles includes assigning a first test cycle to a first DUT in response to detecting, via a DUT status file associated with the first DUT, that the first DUT is in an IDLE state.
19. The one or more non-transitory computer readable media of any of clauses 11-18, wherein assigning the plurality of test cycles further includes assigning a second test cycle to a second DUT while the first DUT remains assigned to the first test cycle.
20. In some embodiments, a computer system comprises one or more memories that include instructions, and one or more processors that are coupled to the one or more memories and that, when executing the instructions, perform distributed video quality evaluations, by performing the operations of: obtaining configuration data associated with a plurality of devices under test (DUTs) and a plurality of test cycles; assigning the plurality of test cycles to available DUTs of the plurality of DUTs; obtaining, from the plurality of DUTs, captured frames generated during execution of the plurality of test cycles; analyzing the captured frames relative to reference data to generate objective video quality metrics; aggregating the objective video quality metrics across at least a subset of the plurality of test cycles to generate aggregated objective video quality metrics, and performing at least one action based at least on the aggregated objective video quality metrics.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing distributed video quality evaluations, the method comprising:
obtaining configuration data associated with a plurality of devices under test (DUTs) and a plurality of test cycles;
assigning the plurality of test cycles to available DUTs of the plurality of DUTs;
obtaining, from the plurality of DUTs, captured frames generated during execution of the plurality of test cycles;
analyzing the captured frames relative to reference data to generate objective video quality metrics;
aggregating the objective video quality metrics across at least a subset of the plurality of test cycles to generate aggregated objective video quality metrics; and
performing at least one action based at least on the aggregated objective video quality metrics.

2. The computer-implemented method of claim 1, wherein the configuration data includes connectivity information associated with the plurality of DUTs.

3. The computer-implemented method of claim 1, wherein the configuration data includes frame-capture parameters associated with the plurality of test cycles.

4. The computer-implemented method of claim 1, wherein the configuration data includes obtaining stage information that identifies one or more stages of a video-processing pipeline at which the captured frames are to be generated.

5. The computer-implemented method of claim 1, wherein assigning the plurality of test cycles includes assigning a first test cycle to a first DUT in response to detecting, via a DUT status file associated with the first DUT, that the first DUT is in an IDLE state.

6. The computer-implemented method of claim 5, wherein assigning the plurality of test cycles further includes assigning a second test cycle to a second DUT while the first DUT remains assigned to the first test cycle.

7. The computer-implemented method of claim 1, wherein obtaining at least a portion of the captured frames includes causing a transfer of the portion of the captured frames from a DUT of the plurality of DUTs after detecting, via a DUT status file associated with the DUT, a transition of the DUT to a DONE state.

8. The computer-implemented method of claim 1, wherein a first portion of the captured frames are obtained at a post-decoding stage of a video-processing pipeline and a second portion of the captured frames are obtained at an upscaling stage of the video-processing pipeline.

9. The computer-implemented method of claim 1, wherein analyzing the captured frames includes generating video multi-method assessment fusion (VMAF) scores.

10. The computer-implemented method of claim 1, wherein analyzing the captured frames further includes generating one or more of VMAF-no enhancement gain (VMAF-NEG) scores or VMAF scores.

11. One or more non-transitory computer readable media storing instructions that, when executed by one or more processors, cause the one or more processors to perform distributed video quality evaluations, by performing the operations of:
obtaining configuration data associated with a plurality of devices under test (DUTs) and a plurality of test cycles;
assigning the plurality of test cycles to available DUTs of the plurality of DUTs;
obtaining, from the plurality of DUTs, captured frames generated during execution of the plurality of test cycles;
analyzing the captured frames relative to reference data to generate objective video quality metrics;
aggregating the objective video quality metrics across at least a subset of the plurality of test cycles to generate aggregated objective video quality metrics; and
performing at least one action based at least on the aggregated objective video quality metrics.

12. The one or more non-transitory computer readable media of claim 11, wherein aggregating the objective video quality metrics includes organizing the objective video quality metrics according to at least one of a DUT identifier, a test cycle identifier, a frame identifier, or a video-processing stage identifier.

13. The one or more non-transitory computer readable media of claim 11, wherein the at least one action includes generating a report based at least on the aggregated objective video quality metrics.

14. The one or more non-transitory computer readable media of claim 11, wherein the at least one action includes comparing a first objective video quality of a first DUT to a second objective video quality of a second DUT based at least on the aggregated objective video quality metrics.

15. The one or more non-transitory computer readable media of claim 11, wherein the configuration data includes connectivity information associated with the plurality of DUTs.

16. The one or more non-transitory computer readable media of claim 11, wherein the configuration data includes frame-capture parameters associated with the plurality of test cycles.

17. The one or more non-transitory computer readable media of claim 11, wherein the configuration data includes obtaining stage information that identifies one or more stages of a video-processing pipeline at which the captured frames are to be generated.

18. The one or more non-transitory computer readable media of claim 11, wherein assigning the plurality of test cycles includes assigning a first test cycle to a first DUT in response to detecting, via a DUT status file associated with the first DUT, that the first DUT is in an IDLE state.

19. The one or more non-transitory computer readable media of claim 18, wherein assigning the plurality of test cycles further includes assigning a second test cycle to a second DUT while the first DUT remains assigned to the first test cycle.

20. A computer system, comprising:
one or more memories that include instructions; and
one or more processors that are coupled to the one or more memories and, when executing the instructions, perform distributed video quality evaluations, by performing the operations of:
obtaining configuration data associated with a plurality of devices under test (DUTs) and a plurality of test cycles;
assigning the plurality of test cycles to available DUTs of the plurality of DUTs;
obtaining, from the plurality of DUTs, captured frames generated during execution of the plurality of test cycles;
analyzing the captured frames relative to reference data to generate objective video quality metrics;
aggregating the objective video quality metrics across at least a subset of the plurality of test cycles to generate aggregated objective video quality metrics; and
performing at least one action based at least on the aggregated objective video quality metrics.
